(19) United States
(12) Patent Application Publication
(10) Pub. No.: US 2009/0163186 A1
(43) Pub. Date: Jun. 25, 2009

(54) APPLICATION PROGRAM INTERFACE AND GRAPHICAL USER INTERFACE FOR EDITORIAL REVIEW OF MOBILE ADVERTISEMENT CAMPAIGNS

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/963,136

(22) Filed: Dec. 21, 2007

(51) Int. Cl. H04M 3/42

(52) U.S. Cl. 455/414.2

(57) ABSTRACT

Systems and methods for facilitating a review of mobile advertisement listings is provided. In one implementation, the method may include displaying information in a user interface for reviewing, the information associated with a mobile advertisement listing and at least one carrier, and at least one keyword associated with the mobile advertisement listing. The method may also include displaying in the user interface reviewing rules associated with a carrier for at least one carrier associated with the mobile advertisement listing and receiving an indication via the user interface of whether the mobile advertisement listing is approved for the carrier based on the displayed reviewing rules associated with the carrier.

### BACKGROUND

The mobile phone may be increasingly important as an information and content access device. Currently there may be over 2 billion mobile phones globally, versus 800 million personal computers. Mobile operators may be increasingly looking to high value data services as a way to overcome the continuing average revenue per user (ARPU) decline for voice services. Billions of dollars may be being spent globally on wireless licenses with billions more in investments in the pipeline for development of infrastructure and services by wireless service and content providers. Carriers may be introducing new data, content and multimedia services as a means of generating new revenue stream, reversing negative ARPU trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers. As consumer adoption of wireless technology continues to increase, marketing via mobile devices may become an important part of all integrated data communications strategies.

### BRIEF DESCRIPTION

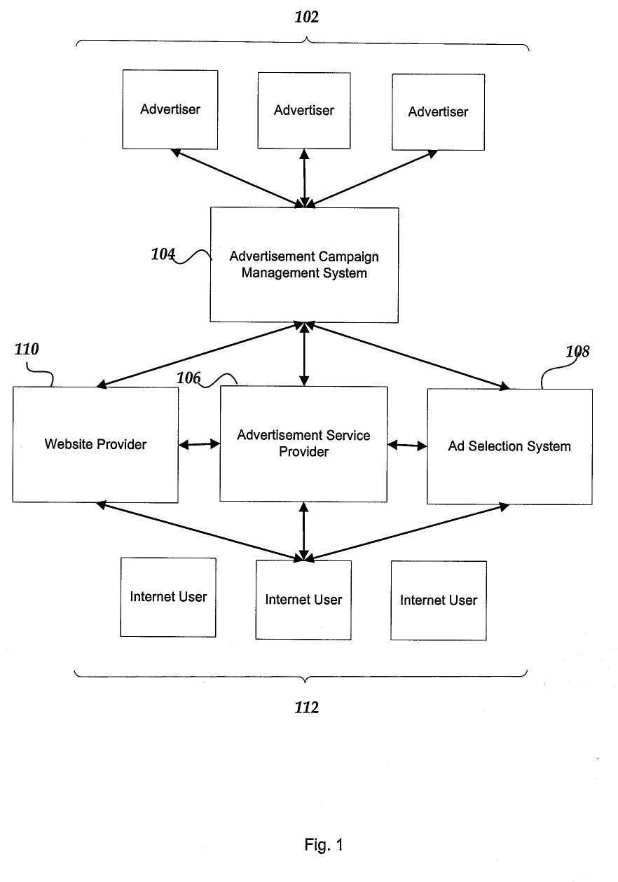

FIG. 1 is a block diagram of an environment in which a system for facilitating a review of mobile advertisement listing may operate.

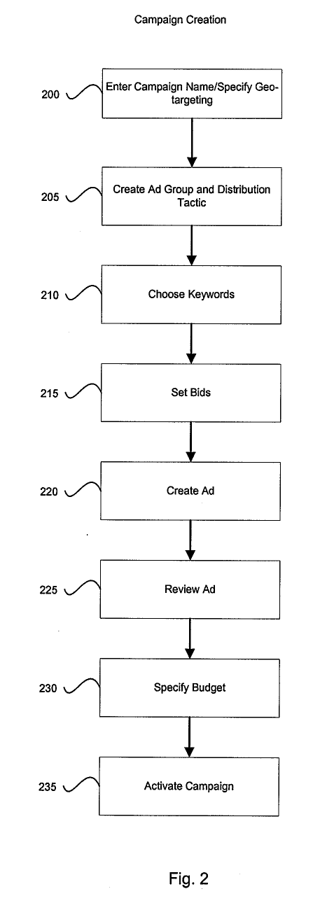

FIG. 2 is a flow chart for creating a mobile based advertisement campaign.

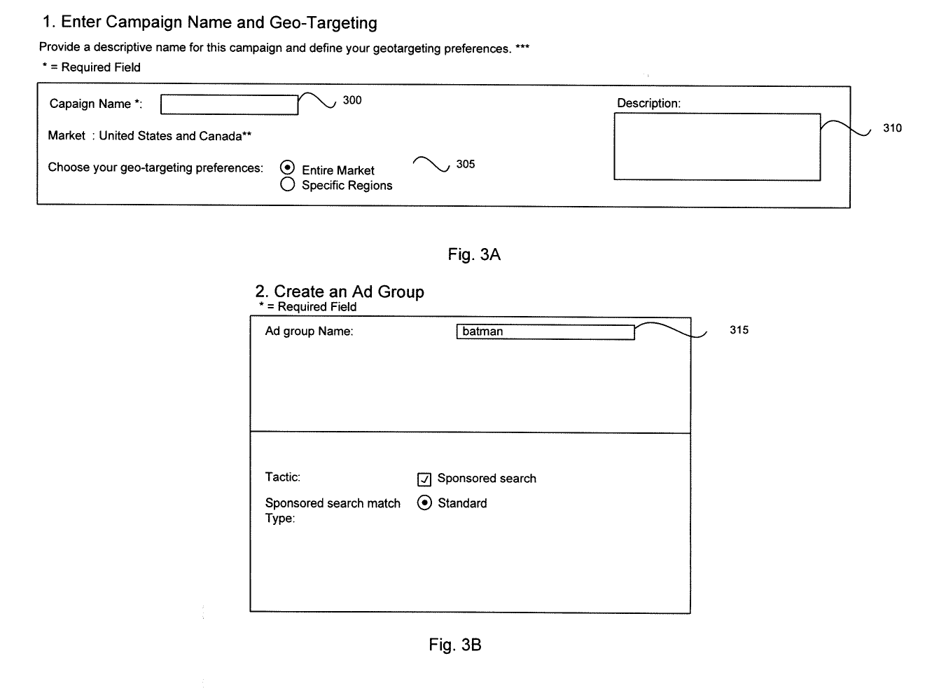

FIG. 3A depicts a user interface with a group of graphical user elements (GUI) for creating a mobile based advertisement campaign.

FIG. 3B depicts a user interface with a group of GUI elements for creating an Ad group.

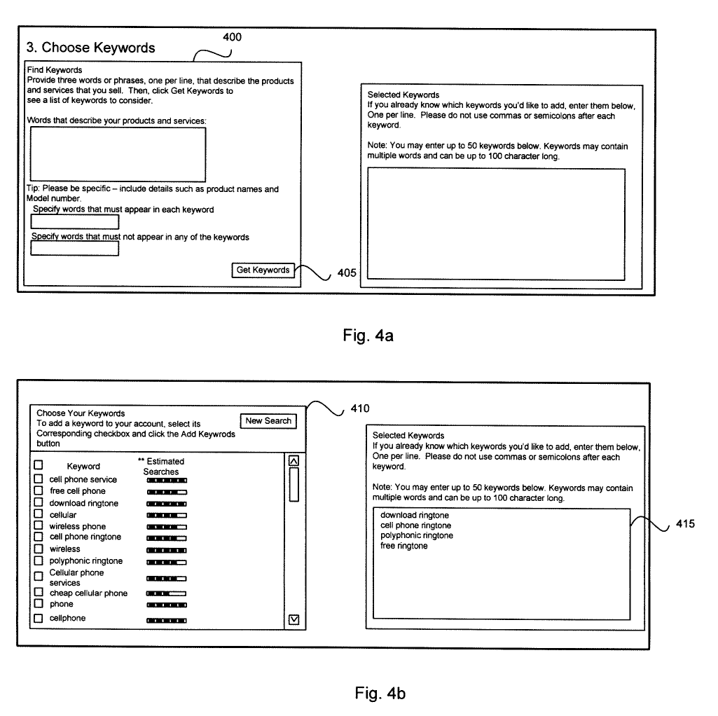

FIG. 4A depicts a user interface with a group of GUI elements that may be utilized to specify keywords to be associated with an Ad group.

FIG. 4B depicts a user interface with a group of GUI elements showing generated keywords.

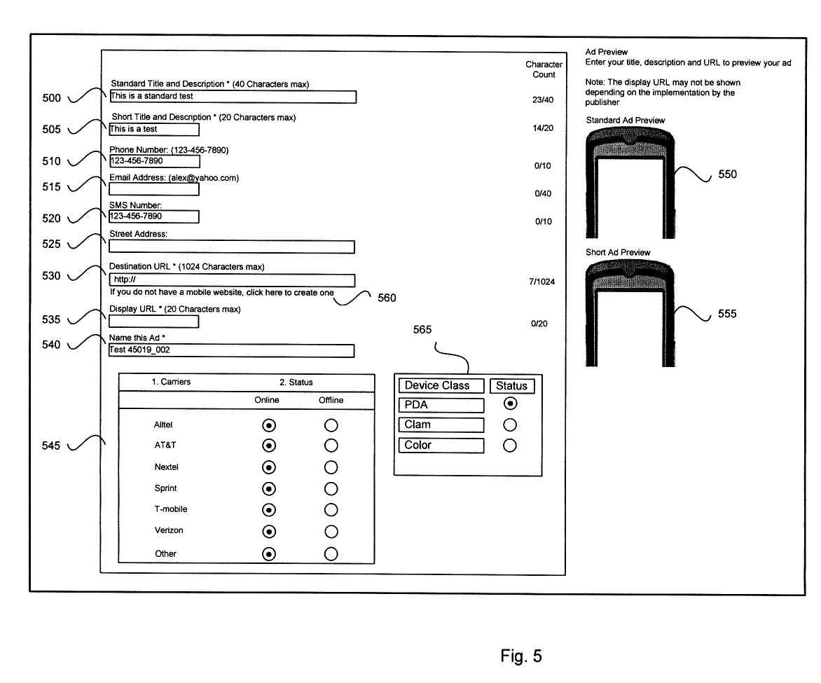

FIG. 5 depicts a user interface with a group of GUI elements that may be utilized to create an advertisement listing for display on a mobile device web browser.

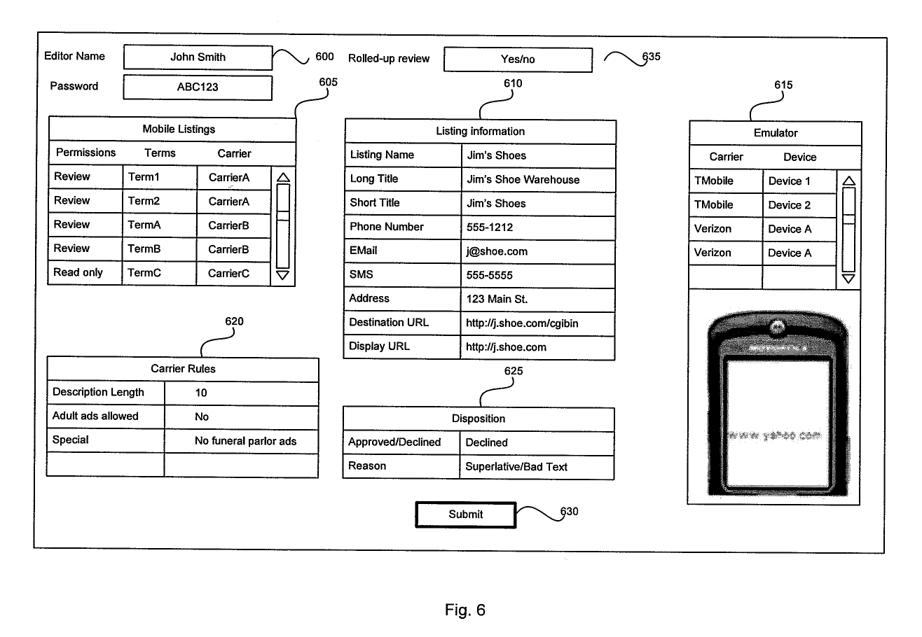

FIG. 6 depicts a user interface with a group of GUI elements that may be utilized by an editor to review a mobile advertisement listing.

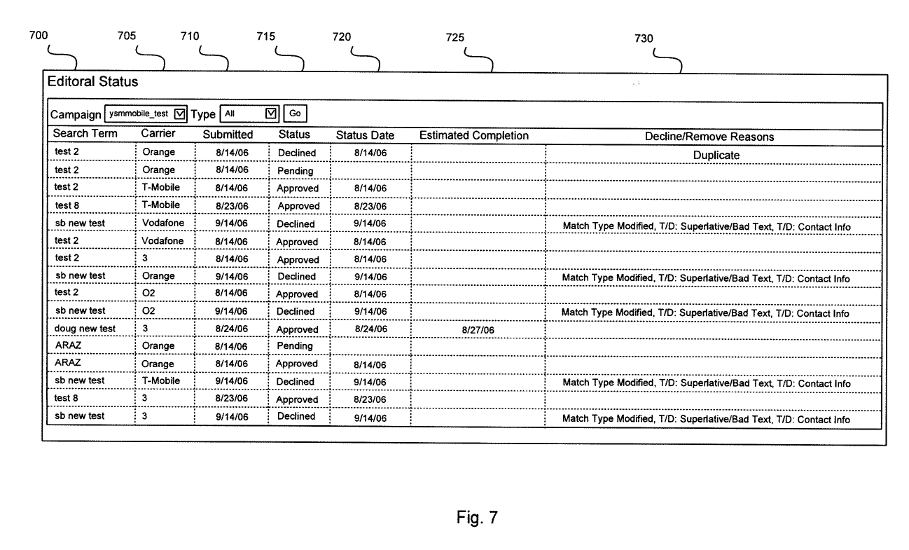

FIG. 7 depicts a user interface with a group of GUI elements that may be utilized by an advertiser to check the status of mobile advertisement listings.

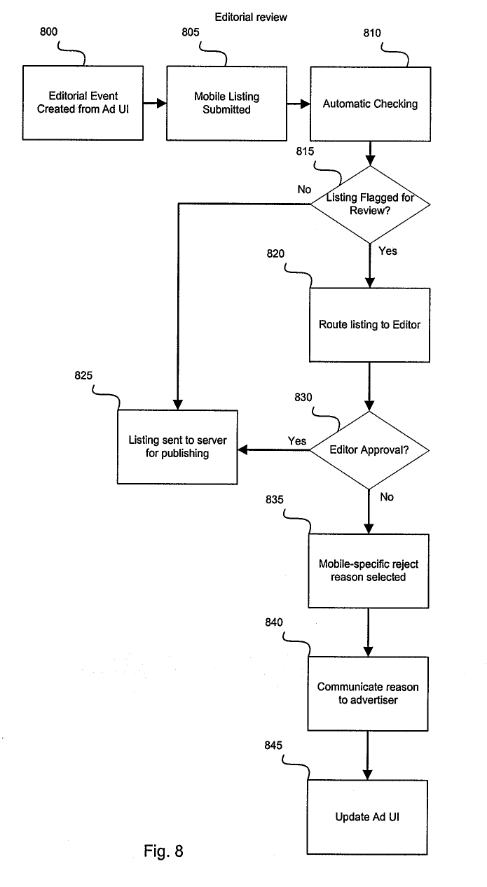

FIG. 8 is a flow chart for providing editorial review of a webpage advertisement.

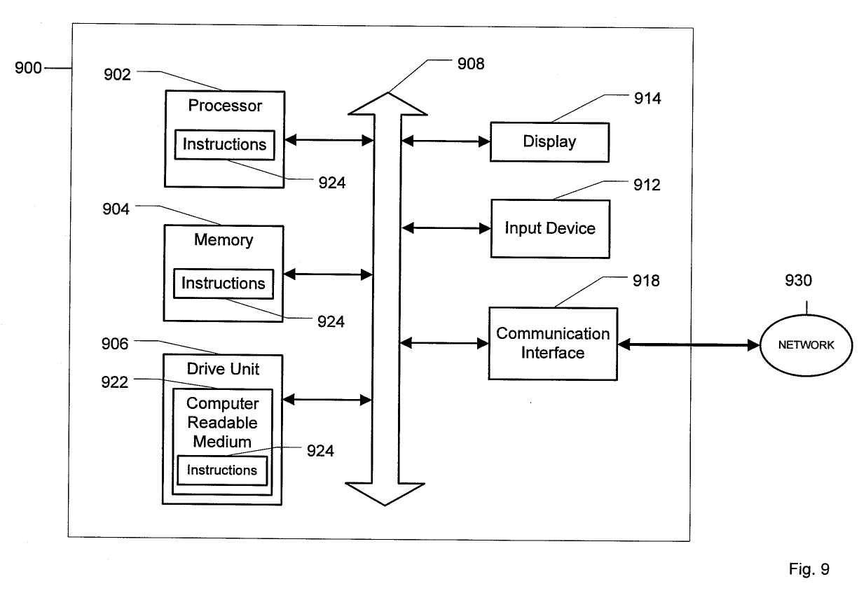

FIG. 9 illustrates a general computer system, which may represent a website provider server, ad provider, ad campaign management system, a mobile device or any of the other computing devices referenced herein.

### DETAILED DESCRIPTION OF THE INVENTION

Mobile advertisement may benefit consumers, mobile service providers, publishers and advertisers by driving incremental revenue, enhancing consumer loyalty and providing convenience for mobile consumers. Mobile data acceptance may have arrived in many parts of the World and may be expected to increase. Mobile destination portals such as Yahoo! (www.yahoo.com) may monetize the mobile searches.

Many mobile advertisement business models may depend upon subscription revenue and purchases of consumables (i.e. ring tones, wallpapers, etc.). Slow roll-out and relatively small incremental revenue streams may be jeopardizing return on investment on current and future investments. Wireless advertisement may now be seen as a way to accelerate revenue growth, especially given the experience of online web advertisement. Search may be emerging as both a key feature and a potential universal interface for discovering and accessing mobile information.

To enable wireless advertisement, a system and method for facilitating a review of mobile advertisement listings is provided. The method may include displaying information in a user interface for reviewing, information associated with a mobile advertisement listing and at least one carrier, and at least one keyword associated with the mobile advertisement listing. The method may also include displaying in the user interface reviewing rules associated with a carrier for at least one carrier associated with the mobile advertisement listing and receiving an indication via the user interface of whether the mobile advertisement listing is approved for the carrier based on the displayed reviewing rules associated with the carrier.

The method may also include receiving, via the user interface, status information related to the reviewing and displaying at least some of the mobile advertisement campaign information and the status information in a second user interface. An emulator for emulating a device may be displayed in the first user interface. A URL may also be displayed and an indication of whether the URL may be valid may be communicated to an advertiser. The method may also include communicating an indication that the mobile advertisement listing is approved for a first carrier and rejected for a second carrier.

FIG. 1 is a block diagram of an environment in which a system for facilitating a review of mobile advertisement listing may operate. The environment 100 may include a plurality of advertisers 102, an ad campaign management system 104, an ad provider 106, an ad selection system 108, a website provider 110, and a plurality of Internet users 112. Generally, an advertiser 102 bids on keywords and creates one or more advertisement listings by interacting with the ad campaign management system 104 in communication with the ad provider 106. The advertisers 102 may purchase advertisement listings based on an auction model of buying ad space or a guaranteed delivery model by which an advertiser pays a minimum cost-per-thousand impressions (i.e., CPM) to display the advertisement listings or any other procurement model known in the art. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The advertisement listings may be a graphical ad that appears on a website viewed by Internet users 112, a sponsored search listing that is served to an Internet user 112 in response to a search performed at a search engine, a video ad, a graphical banner ad based on a sponsored search listing, an advertisement specifically created to be displayed on mobile devices, and/or any other type of online marketing media known in the art.

When an Internet user 112 views a website served by the website provider 110, the ad provider 106 may serve one or more advertisement listings to the Internet user 112 based on advertisement listings selected by the ad selection system 108. Generally, the ad selection system 108, which in some implementations may be part of the ad provider 106, selects one or more advertisement listings to serve to the Internet user 112 based on factors such as a type of device that may receive the advertisement listings; the specific webpage that may display the webpage; the location in the webpage where the advertisement listings may be displayed; properties such as demographics, past behaviors, or inferred or declared interests associated with the Internet user 112; where the Internet user 112 may be currently located; a time of day; a keyword or image present in the content of the webpage where the advertisement listings may be displayed; and/or a keyword received at a search engine.

When the advertisement listings are served, the ad campaign management system 104 and/or the ad provider 106 may record and process information associated with the served advertisement listings for purposes such as billing, reporting, or ad campaign optimization. For example, the ad campaign management system 104 and/or the provider 106 may record the factors that caused the ad selection system 108 to select the served advertisement listings; whether the Internet user 112 clicked on a URL or other link associated with one of the served advertisement listings; what additional search listings or advertisement listings were served with each served advertisement listing; a position of an advertisement listing when the Internet user 112 clicked on a advertisement listing; and/or whether the Internet user 112 clicked on a different advertisement listing when a advertisement listing was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. In addition, if the advertiser 102 provides conversion data (subscriptions, sales, etc.) to the ad campaign management system 104 and/or the ad provider 106, then that data may also be recorded and processed. The systems described below for facilitating a review of mobile advertisement listing may operate in the environment of FIG. 1.

FIG. 2 is a flow chart for creating a mobile based advertisement campaign. In block 200, a user interface for creating a mobile based advertisement campaign may be presented to an advertiser. The user interface may enable specifying a name for the mobile based advertisement campaign and geo-targeting preference information for the mobile based advertisement campaign. The mobile based advertisement campaign may be comprised of numerous advertiser customized and defined groups of advertisement campaign data, also known as Ad groups. These Ad groups may further be comprised of numerous advertisement listings. The advertisement listings may correspond to information that may be displayed to a mobile device user in response to, for example, a keyword search via a search browser running on the mobile device. In block 205, a user interface for creating an Ad group and associating a distribution tactic with the Ad group may be presented to the advertiser. The user interface may enable an advertiser to associate one or more carriers with the Ad group, thereby limiting the user who may view an advertisement listing of the Ad group to just those users who are customers of the selected carriers.

In block 210, a user interface for specifying keywords for association with the Ad group may be presented to the advertiser. This user interface may enable the advertiser to generate numerous keywords based on only a few words or phrase. In block 215, a user interface may be presented to the advertiser that may enable the advertiser to bid on keywords in the Ad group. The user interface may provide the ability to apply the same bid amount to all carriers selected in the Ad group. The user interface may also provide the ability to override a bid amount for certain carriers. For example, a higher bid may be specified for a carrier of particular interest to the advertiser while bids for other carriers may be equal to the Ad group bid.

In block 220, a user interface for creating a mobile based advertisement listing for association with the Ad group may be presented to the advertiser. The user interface may enable the advertiser to specify information in the advertisement listing and may enable the advertiser to target customers based on their choice of carrier and/or the class of device, such as PDA or clam phone, that the customer may be utilizing. In block 225, a user interface for reviewing the advertisement listing may be presented to the advertiser. In block 230, a user interface for specifying an advertisement budget may be presented to the advertiser. The user interface may enable the advertiser to specify the method of distributing the advertisement budget across the mobile based advertisement campaign. In block 235, the mobile advertisement campaign may be activated. Once activated the advertisement listings may be shown, for example, in response to a keyword search via a search browser running on a mobile device or in response to a keyword from the content of a webpage.

FIG. 3A depicts a user interface with a group of graphical user elements (GUI) for creating a mobile based advertisement campaign. Shown in FIG. 3A is a campaign name field 300, geo-targeting preference buttons 305, and a description text box 310. The GUI elements shown in FIG. 3A may be shown on a webpage and may be presented to an advertiser so that the advertiser may create the mobile based advertisement campaign via an internet browser. The campaign name field 300 may be utilized to specify a name for the mobile based advertisement campaign to be associated with groups of advertisement listings. For example, a shoe manufacturer may choose to advertise shoes for the workplace and shoes for sports. The advertiser may create a generalized advertisement campaign for selling all shoes, but may want different advertisement listings for the different styles of shoes. For example, one advertisement listing may be geared towards workplace clothing and the other advertisement listing may be geared towards sports.

The geo-targeting preference buttons 305 may be utilized to specify a geographic targeting region for the mobile based advertisement campaign. For example, an advertiser may decide that the most efficient place to advertise may be in the United States. In this case, the advertiser may select a geo-targeting preference button 305 associated with the United States. The advertiser may also decide to advertise globally. In this case, the advertiser may select a geo-targeting preference button 305 associated with the entire world. Restricting the geographic scope of an advertisement campaign via a geo-targeting preference may allow for more efficient use of advertisement dollars. For example, a manufacturer incapable of shipping products outside of the United States may save money by not targeting those who cannot receive their products. The description text box 310 may be utilized to specify a description for the advertisement campaign.

FIG. 3B depicts a user interface with a group of GUI elements for creating an Ad group. Shown in FIG. 3B is an Ad group name field. The GUI elements shown in FIG. 3B may be shown on a webpage and may be presented to an advertiser so that the advertiser may create an Ad group for an advertisement campaign via an internet browser. The Ad group name field 315 may be a name utilized by an advertiser to describe the group of advertisement listings that may be created within this Ad group.

FIG. 4a depicts a user interface with a group of GUI elements that may be utilized to specify keywords to be associated with an Ad group. Shown in FIG. 4a is a region/phrase text field 400, a get keywords button 405. FIG. 4b depicts a user interface with a group of GUI elements showing generated keywords. Shown in FIG. 4b is a generated keyword list 410, and a selected keyword list 415. The GUI elements shown in FIG. 4a and FIG. 4b may be shown on a webpage and may be presented to an advertiser so that the advertiser may specify keywords for an Ad group via an internet browser. The region/phrase text field 400 may be utilized by an advertiser to specify words and/or phrases that may describe the products and/or services that the advertiser may desire to associate with an advertisement listing. The get keywords button 405 may enable generating a list of keywords that may be associated with the words and/or phrases entered by the advertiser in the region/phrase text field 400. The keywords in the list may reside in a database and may, for example, have been associated with various words and phrases via a statistical process. The generated keyword list 410 may be utilized to show the generated keywords and may further allow the advertiser to select a subset of the keywords in the list. The selected keyword list 415 may be utilized to display those keywords ultimately selected from the generated keyword list 410 by the advertiser. The selected keywords may then be associated with an Ad group.

In operation, an advertiser may wish to associate an advertisement listing with, for example, a cellular telephone product. The advertiser may then enter the phrase “cellular phone” into the region/phrase text field 400. The advertiser may then press the get keywords button 405, which may result in various keywords related to the phrase “cellular phone” being displayed in the generated keyword list 410. The advertiser may then select only those keywords that the advertiser he may wish to later bid on. Those words may then be displayed in the selected keyword list 415 and may ultimately be associated with advertisement listings in an Ad group.

FIG. 5 depicts a user interface with a group of GUI elements that may be utilized to create an advertisement listing for display on a mobile device web browser. Shown in FIG. 5, is a standard title and description text field 500, a short title and description text field 505, a phone number field 510, an email address field 515, an SMS number field 520, a street address field 525, a description URL field 530, a display URL field 535, an ad name field 540, carrier selection buttons 545, device class selection buttons 565, a mobile website creation link 560, a standard ad preview emulator 550, and a short ad preview emulator 555. The GUI elements shown in FIG. 5 may be shown on a webpage that may be presented to an advertiser so that the advertiser may create the advertisement listing via an internet browser.

The standard title and description text field 500 and the short title and description text field 505 may be utilized to specify standard and shortened versions of an advertisement listing. The standard title may, for example, be utilized where the listing may be displayed on a mobile device with a larger screen, such as an iPhone™ that may have a 3.5 inch screen with a resolution of 320×480 pixels. The short title may, for example, be utilized where the listing may be displayed on a mobile device with a smaller screen, such as a Motorola RAZR™ that may have a 2.2 inches screen with a resolution of 240×320 pixels.

The phone number field 510, email address field 515, SMS number field 520, and street address field 525 may be utilized to enter a phone number, email address, SMS number, and street address for association with an advertisement listing. The advertisement listing ultimately shown to a user of a mobile device may comprise some or all of this information.

A destination URL field 530 and display URL field 535 may be provided for associating a destination URL with an advertisement listing. The display URL field 535 may correspond to a truncated version of the destination URL and may be displayed in the advertisement listing instead of the destination URL for ease of viewing. It may be desirable for the destination URL to address a website suitable for display on a mobile device. In this case, an advertiser may specify such a URL. If a website suitable for display on a mobile device does not exist, the advertiser may create a website suitable for display on a mobile device by selecting the mobile website creation link 560. This link may lead the advertiser to another website that may enable creating a website suitable for display on a mobile device. The ad name field 540 may be utilized to specify a name for a particular advertisement listing within the Ad group.

The carrier selection buttons 545 may be utilized to target specific carries. The device class selection buttons 565 may be utilized to target specific classes of device. An advertiser may utilize these buttons to control where the advertisement listing may be shown. For example, selecting T-Mobile™ as the carrier may result in the advertisement listing only being displayed to T-Mobile™ customers in response to, for example, a customer submitting a search query including the keywords associated with the Ad group or a customer viewing a webpage whose contents include the keywords associated with the Ad group. Specifying a device class may narrow the group of customers to those with a mobile device matching the device class description. For example, selecting a PDA device class may result in only those customers with PDA phones, such as an iPhone™ or Blackberry™ being targeted. One advantage of this approach is that advertisers may be able to target customers that may pay more for products. It may be the case that customers with, for example, PDA phones, spend more money on products. It is to be understood that there may be many different ways to classify a mobile device. For example, a mobile device may be classified as a clam type device or it may be classified as having a color display. Such classifications are only meant as examples. Many other classifications may exist as well.

The standard ad preview emulator 550 and short ad preview emulator 555 may be utilized to show an advertiser how a particular advertisement listing may appear on a specific device. In this regard, the emulation screen may correspond to a particular mobile device. For example, a Motorola RAZR™ phone may be emulated such that the advertiser may be able to determine how many characters to utilize in a potential advertisement listing. If the advertisement listing does not display correctly, the advertiser may change the advertisement listing until the advertisement listing may be suitable for display on the mobile device. The advertisement listing shown in the standard ad preview emulator 550 may include all or only a subset of the fields entered by the advertiser. For example, the advertisement listing may include the standard title and description, the phone number, email address, SMS address, street address, and display URL. The advertisement listing shown in the short ad preview emulator 555 may include a subset of the fields entered. For example, in the short ad preview emulator 555, the advertisement listing may include the short title rather than the standard title and/or the advertisement listing may omit certain fields, such as the advertiser's address.

Providing emulators to preview advertisement listings may enable an advertiser to optimize an advertisement listing for a broad range of mobile devices, thus maximizing the impact of an advertisement listing. For example, screen resolutions among mobile devices may be different. Some mobile screens may be black and white while other mobile screens may be color. There may be additional graphical information cluttering the screen, such as battery level icons, signal strength icons, and the like. Thus, knowing about these parameters may enable the advertiser to create better advertisement listings.

FIG. 6 depicts a user interface with a group of GUI elements that may be utilized by an editor to review a mobile advertisement listing. Shown in FIG. 6 are fields for an editor's name and password 600, a mobile advertisement listing review list box 605, listing information fields 610, a mobile device emulator 615, a carrier rules list box 620, a disposition list box 625, a submit button 630, and a “rolled-up” review selection box 635. The GUI elements shown in FIG. 6 may be shown on a webpage that may be presented to an editor so that the editor may review mobile advertisement listings and submit status information via an internet browser.

The fields for an editor's name and password 600 may be utilized to authenticate the editor with the system. In some implementations, editors are authenticated so that all editors do not have access to all the mobile advertisement listings. The mobile advertisement listing review list box 605 may provide information to the editor related to the number of mobile advertisement listing submissions that may need processing. The mobile advertisement listing review list box 605 may comprise information related to keyword terms and carriers. The mobile advertisement listing review list box 605 may also indicate which mobile advertisement listings are reviewable by the authenticated editor. Mobile advertisement listings that may not be reviewed by the authenticated editor may, for example, be grayed out, where advertisement listings that are reviewable by the authenticated editor may be selectable.

The “rolled-up” review selection box 635, may allow the editor to specify the way in which the editor may choose to review listings. For example, one editor may prefer to do a “rolled-up” review. This may result in the mobile advertisement listing review list box 605 being sorted based on advertisement listings so that the editor may concentrate on an advertisement listing as it relates to various carriers. Alternatively, the editor may prefer to do a carrier specific review. This may result in the mobile advertisement listing review list box 605 being sorted based on the carrier so that the editor may concentrate on a specific carrier.

The listing information fields 610 may provide mobile advertisement listing information related to one or more items selected in the mobile advertisement listing review list box 605. The listing information fields 610 may include, for example, some or all of the information the advertiser entered in the fields shown in FIG. 5. The editor may review this information to verify the integrity of the information. For example, the editor may verify the address and phone number associated with the mobile advertisement listing. The editor may also verify that the destination URL associated with the mobile advertisement exists.

An editor may utilize the mobile device emulator 615 to verify that the mobile advertisement listing appears correct on a given device. In some implementations, the editor may be able to select to emulate the mobile advertisement listing on a device based on those devices available from a particular carrier. The emulator typically emulates the display characteristics of a selected device such as a number of pixels on a display of the device or a color capability of a display of the device (color vs. black and white).

The carrier rules list box 620 may provide information to the editor related to the checks the editor may have to perform on the mobile advertisement listing. In some implementations, the rules may vary from carrier to carrier. For example, one carrier may allow adult themed advertisement while another may not. The carrier rules list box 620 may also indicate, for example, a maximum number of allowable characters for a given device.

The editor may utilize the disposition list box 625 to indicate whether the mobile advertisement listing is acceptable. In the case where a mobile advertisement listing may not be acceptable, the editor may provide a reason. For example, the editor may find that inappropriate language may be used in a mobile advertisement listing. If the rules for the particular carrier prohibit such language, the editor may note that in the reason field of the disposition list box 625.

After reviewing the mobile advertisement listing, an editor may submit the status of the review by pressing the submit button 630. Where a reason for rejecting a mobile advertisement listing is given, the advertiser may be notified of the rejection. For example, an email may be sent to the advertiser alerting the advertiser that an editor has rejected the mobile advertisement listing. Pressing the submit button 630 may also update a status field on a user interface for providing mobile advertisement listing status to advertisers. When the mobile advertisement listing meets all of the requirements of a particular carrier, pressing the submit button 630 may result in the mobile advertisement listing being published so that the mobile advertisement listing may be served to users in response to actions such as users submitting search queries or viewing particular websites.

FIG. 7 depicts a user interface with a group of GUI elements that may be utilized by an advertiser to check the status of mobile advertisement listings. Shown in FIG. 7 is a keyword column 700, a carrier column 705, a date submitted column 710, a status column 715, an estimated completion date column 725, and a column giving any reason for declining or removing an advertisement 730. The GUI elements shown in FIG. 7 may be shown on a webpage that may be presented to an advertiser so that the advertiser may review mobile advertisement listings and status information via an internet browser.

The keyword column 700 may include a list of keywords associated with a mobile advertisement listing. The carrier column 705 may include various mobile device carriers associated with the keywords. The date submitted column 710 may be the date on which a mobile advertisement listing may have been submitted for editorial review for a particular carrier. The status column 715 may include information about whether a keyword may have been approved for use as a keyword for a mobile advertisement listing for a particular carrier. For example, the status column 715 may indicate that the keyword may have been declined, may be pending review, or that the keyword may have been approved. Information in the status column may correspond to information entered by the editor via the user interface shown in FIG. 6.

The estimated completion column 725 may provide a date upon which editorial review of a keyword may be completed. The column giving the reasons for declining a keyword 730 may provide a more detailed reason of why a keyword may have been rejected. This information may correspond to information provided by the editor via the user interface shown in FIG. 6. A keyword term may be rejected, for example, because a keyword may have been a duplicate keyword. In other words, the keyword may have already been associated with a particular mobile advertisement listing for the particular carrier. If this is the case, the advertiser may not want the duplicate term because this may result in an increased fee for a word that adds no value. Another reason for rejecting a term may, for example, be because the mobile advertisement listing uses bad text. It is to be appreciated that there may be numerous reasons for rejecting keywords and the reasons given above are only exemplary.

FIG. 8 is a flow chart for providing editorial review of a mobile advertisement listing. At block 800, an editorial event may occur. An editorial event may be any event that triggers review of a mobile advertisement listing. The editorial event may occur for a variety of reasons. For example, the editorial event may be triggered because an advertiser creates a mobile advertisement listing, an advertiser associates keywords with a mobile advertisement listing, or a new carrier is associated with a mobile advertisement listing.

At block 805, a mobile advertisement listing along with carrier attributes may be submitted into the editorial process. Carrier attributes may, for example, include the name of the carrier. In some implementations, the mobile advertisement listings may be routed to a mobile-only queue for editorial review instead of routing the mobile advertisement listing to a generalized reviewing queue. For example, advertisement listings not targeting mobile devices may be routed to the generalized queue for review while advertisement listings such as mobile advertisement listings that target mobile devices may be routed to a queue that may only include mobile advertisement listings directed towards mobile devices.

At block 810, a mobile specific automatic check may be performed. This may be accomplished by checking a mobile advertisement listing against several databases. For example, the mobile advertisement listing may be checked against a risk data set, which may be utilized to scan for words related to adult themes, gambling, blocked text, suspect text, trademarks, or prescription drug terms. The mobile advertisement listing may also be checked against a format dataset, which may be utilized to check parameters such as field length. In some implementations the format dataset may include mobile specific data. The mobile specific data may be necessary because different mobile devices may have different formatting requirements. For example, the screen size on various mobile devices may be different. A mobile device with a larger screen may be able to display a longer mobile advertisement listing than a mobile device with the smaller screen. The mobile advertisement listing may also be checked against a dataset including mobile specific and market specific terms.

At block 815, the ad campaign management system determines if a mobile advertisement listing is flagged for manual review. If, for example, the mobile advertisement listing is not flagged for manual review, then at block 825, the mobile advertisement listing may be sent to a web server for publishing over the internet. In some implementations, it may not be necessary to review a mobile advertisement listing where the mobile advertisement listing has a low monetary value or where the mobile advertisement listing utilizes low volume terms. To prevent a mobile advertisement listing with bad URLs from being published, a mobile-site crawl tool may be utilized to verify that the URL works.

Referring back to block 815, if the mobile advertisement listing is flagged for manual review, then at block 820 the mobile advertisement listing may be routed to a editor for review. The editor may be a person who has specific permission to review the mobile advertisement listing or may be a person with the ability to assign the mobile advertisement listing to other editors who may have permission to review the mobile advertisement listing. The editor may be able to perform an atomic review of terms, creatives, and URLs, as well as a relationship review. The relationship review may be done to ensure that the terms, creatives, and URL are relevant to each other. If they are not relevant to one another then the editor may reject the submission. For atomic review, no regard may be given to the relevance between the terms, creatives, and URL. Rather, this type of review may be utilized to filter out sensitive terms, bad creatives and broken/sensitive URLs. The mobile advertisement listings may also be reviewed against the editorial rules associated with each carrier associated with the mobile advertisement listing.

In some implementations, the editors may be able to set a reviewing preference. For example, one editor may prefer to do a “rolled-up” review. This may result in mobile advertisement listing targeted for review being presented to the editor in such a way so that the editor may concentrate on an advertisement listing as it relates to various carriers. Alternatively, the editor may prefer to do a carrier specific review. This may result in mobile advertisement listing targeted for review being presented to the editor in such a way so that the editor may concentrate on a specific carrier.

At block 830, the ad campaign management system determines whether the editor approves the mobile advertisement listing. If the editor approves the mobile advertisement listing, the mobile advertisement listing may be sent to a web server for publishing at block 825. However, if the editor does not approve the mobile advertisement listing, then at block 835, a reason for the rejection may be given.

The editor may be able approve or disapprove of a mobile advertisement listing on a carrier-by-carrier basis. In other words, the editor may approve a mobile advertisement listing for a first carrier, but reject the mobile advertisement listing for a second carrier. If a mobile advertisement listing is rejected, then at block 840, the reason for the rejection may be communicated to the advertiser. For example, the editorial status may be communicated to the advertisers via a user interface of an ad campaign management system or via email or text messaging. In some implementations, the text associated with the rejection that is communicated to the advertiser may be mobile-specific. In other words, the rejection may specify that the mobile advertisement listing may not be approved for a first carrier.

At block 845, a status web page may be updated to show the reason why the mobile advertisement listing may have been rejected. For example, the web page may indicate that there may have been a superlative text or that the contact information may have been incorrect.

FIG. 9 illustrates a general computer system, which may represent a website provider server, ad provider, ad campaign management system, a mobile device or any of the other computing devices referenced herein. The computer system 900 may include a set of instructions 924 that may be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 924 (sequential or otherwise) that specify actions to be taken by that machine. In one embodiment, the computer system 900 may be implemented using electronic devices that provide voice, video or data communication. Further, while a single computer system 900 may be illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, such as, a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 904 may include a cache or random access memory for the processor 902. Alternatively or in addition, the memory 904 may be separate from the processor 902, such as a cache memory of a processor, the system memory, or other memory. The memory 904 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 904 may be operable to store instructions 924 executable by the processor 902. The functions, acts or tasks illustrated in the figures or described herein may be performed by the programmed processor 902 executing the instructions 924 stored in the memory 904. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906.

Additionally, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the system 900.

The computer system 900 may also include a disk or optical drive unit 906. The disk drive unit 906 may include a computer-readable medium 922 in which one or more sets of instructions 924, e.g. software, can be embedded. Further, the instructions 924 may perform one or more of the methods or logic as described herein. The instructions 924 may reside completely, or at least partially, within the memory 904 and/or within the processor 902 during execution by the computer system 900. The memory 904 and the processor 902 also may include computer-readable media as discussed above.

The present disclosure contemplates a computer-readable medium 922 that includes instructions 924 or receives and executes instructions 924 responsive to a propagated signal; so that a device connected to a network 930 may communicate voice, video, audio, images or any other data over the network 930. The instructions 924 may be implemented with hardware, software and/or firmware, or any combination thereof. Further, the instructions 924 may be transmitted or received over the network 930 via a communication interface 918. The communication interface 918 may be a part of the processor 902 or may be a separate component. The communication interface 918 may be created in software or may be a physical connection in hardware. The communication interface 918 may be configured to connect with a network 930, external media, the display 914, or any other components in system 900, or combinations thereof. The connection with the network 930 may be a physical connection, such as a wired Ethernet connection or may be established wirelessly as discussed below. Likewise, the additional connections with other components of the system 900 may be physical connections or may be established wirelessly.

The network 930 may include wired networks, wireless networks, or combinations thereof. The wireless network may be a cellular telephone network, an 802.11, 802.16, 802.20, or WiMax network. Further, the network 930 may be a public network, such as the Internet, a private network, such as an intranet, or combinations thereof, and may utilize a variety of networking protocols now available or later developed including, but not limited to TCP/IP based networking protocols.

The computer-readable medium 922 may be a single medium, or the computer-readable medium 922 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 922 may include a solid-state memory such as a memory card or other package that houses one or more non-volatile read-only memories. The computer-readable medium 922 also may be a random access memory or other volatile re-writable memory. Additionally, the computer-readable medium 922 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The functions described herein may also be accomplished by way of an application program interface for facilitating a review of mobile advertisement listing. Information associated with a mobile advertisement listing and at least one carrier and at least one keyword associated with the mobile advertisement listing may be communicated via the application program interface. Reviewing rules associated with a carrier for the carrier associated with the mobile advertisement listing may be communicated via the application program interface as well. An indication of whether the mobile advertisement listing is approved for the carrier based on the displayed reviewing rules associated with the carrier may be received via the application program interface.

The functions described herein may also be accomplished by way of a system for facilitating a review of mobile advertisement listing. The system may include one or more circuits that enable communicating, via an application program interface, information associated with a mobile advertisement listing and at least one carrier and at least one keyword associated with the mobile advertisement listing. The circuits may also enable communicating via said application program interface reviewing rules associated with a carrier for the at least one carrier associated with the mobile advertisement listing; and receiving, via said application program interface an indication of whether the mobile advertisement listing is approved for the carrier based on the displayed reviewing rules associated with the carrier.

The various embodiments disclosed herein advantageously allow for the review of mobile advertisement listing by allowing an editor to review the mobile advertisement information and either allow or reject the mobile advertisement listing on a carrier by carrier basis. Another advantage is that the editor may see how a mobile advertisement listing may appear on various mobile devices via an emulator.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

What is claimed is:

1. A method for facilitating a review of mobile advertisement listing, the method comprising:
displaying information in a user interface for review, the information associated with a mobile advertisement listing and at least one carrier and at least one keyword associated with the mobile advertisement listing;
displaying in the user interface reviewing rules associated with a carrier for the at least one carrier associated with the mobile advertisement listing; and
receiving an indication via the user interface of whether the mobile advertisement listing is approved for the carrier based on the displayed reviewing rules associated with the carrier.

2. The method according to claim 1, further comprising:
receiving, via the user interface, status information related to the review of the displayed information.

3. The method according to claim 2, further comprising:
displaying at least some of the mobile advertisement campaign information and the status information in a second user interface.

4. The method according to claim 1, further comprising:
displaying an emulator in the user interface operative to emulate a display of the mobile advertisement listing in a mobile device.

5. The method according to claim 1, wherein the displayed information comprises a universal resource locator (URL) associated with the mobile advertisement listing.

6. The method according to claim 5, further comprising:
receiving via the user interface an indication of whether the URL associated with the mobile advertisement listing is valid.

7. The method according to claim 1, further comprising:
communicating the indication of whether the mobile advertisement listing is approved for the carrier to an advertiser.

8. The method according to claim 1, further comprising:
communicating an indication that the mobile advertisement listing is approved for a first carrier and rejected for a second carrier.

9. A machine-readable storage medium having stored thereon, a computer program having at least one code section for facilitating a review of mobile advertisement listing, the at least one code section being executable by a machine for causing the machine to perform acts of:
displaying information in a user interface for review, the information associated with a mobile advertisement listing and at least one carrier and at least one keyword associated with the mobile advertisement listing;
displaying in the user interface reviewing rules associated with a carrier for the at least one carrier associated with the mobile advertisement listing; and
receiving an indication via the user interface of whether the mobile advertisement listing is approved for the carrier based on the displayed reviewing rules associated with the carrier.

10. The machine-readable storage according to claim 9, further comprising at least one code section being executable by a machine for causing the machine to perform acts of:
receiving, via the user interface, status information related to the review of the displayed information.

11. The machine-readable storage according to claim 10, further comprising at least one code section being executable by a machine for causing the machine to perform acts of:
displaying at least some of the mobile advertisement campaign information and the status information in a second user interface.

12. The machine-readable storage according to claim 9, further comprising at least one code section being executable by a machine for causing the machine to perform acts of:
displaying an emulator in the user interface operative to emulate a display of the mobile advertisement listing in a mobile device.

13. The machine-readable storage according to claim 9, wherein the displayed information comprises a universal resource locator (URL) associated with the mobile advertisement listing.

14. The machine-readable storage according to claim 13, further comprising at least one code section being executable by a machine for causing the machine to perform acts of:
receiving via the user interface an indication of whether the URL associated with the mobile advertisement listing is valid.

15. The machine-readable storage according to claim 9, further comprising at least one code section being executable by a machine for causing the machine to perform acts of:
communicating the indication of whether the mobile advertisement listing is approved for the carrier to an advertiser.

16. The machine-readable storage according to claim 9, further comprising at least one code section being executable by a machine for causing the machine to perform acts of:
communicating an indication that the mobile advertisement listing is approved for a first carrier and rejected for a second carrier.

17. A system for facilitating a review of mobile advertisement listing, the system comprising:
circuitry that enables displaying information in a user interface for review, the information associated with a mobile advertisement listing and at least one carrier and at least one keyword associated with the mobile advertisement listing;
wherein the circuitry further enables displaying in the user interface reviewing rules associated with a carrier for the at least one carrier associated with the mobile advertisement listing and receiving an indication, via the user interface, of whether the mobile advertisement listing is approved for the carrier based on the displayed reviewing rules associated with the carrier.

18. The system according to claim 17, wherein the circuitry further enables receiving, via the user interface, status information related to the review of the displayed information.

19. The system according to claim 18, wherein the circuitry further enables displaying at least some of the mobile advertisement campaign information and the status information in a second user interface.

20. The system according to claim 17, wherein the circuitry further enables displaying an emulator in the user interface operative to emulate a display of the mobile advertisement listing in a mobile device.

21. The system according to claim 17, wherein the displayed information comprises a universal resource locator (URL) associated with the mobile advertisement listing.

22. The system according to claim 21, wherein the circuitry further enables receiving via the user interface an indication of whether the URL associated with the mobile advertisement listing is valid.

23. The system according to claim 17, wherein the circuitry further enables communicating the indication of whether the mobile advertisement listing is approved for the carrier to an advertiser.

24. A method for facilitating a review of mobile advertisement listing, the method comprising:
communicating, via an application program interface, information associated with a mobile advertisement listing and at least one carrier and at least one keyword associated with the mobile advertisement listing;
communicating via said application program interface reviewing rules associated with a carrier for the at least one carrier associated with the mobile advertisement listing; and
receiving, via said application program interface, an indication of whether the mobile advertisement listing is approved for the carrier based on the displayed reviewing rules associated with the carrier.

25. A machine-readable storage medium having stored thereon, a computer program having at least one code section for facilitating a review of mobile advertisement listing, the at least one code section being executable by a machine for causing the machine to perform acts of:
communicating, via an application program interface, information associated with a mobile advertisement listing and at least one carrier and at least one keyword associated with the mobile advertisement listing;
communicating via said application program interface reviewing rules associated with a carrier for the at least one carrier associated with the mobile advertisement listing; and
receiving, via said application program interface, an indication of whether the mobile advertisement listing is approved for the carrier based on the displayed reviewing rules associated with the carrier.
